(19) United States
(12) Patent Application Publication
(10) Pub. No.: US 2024/0356208 A1
(43) Pub. Date: Oct. 24, 2024

(54) ANTENNA MODULE AND DEVICE INCLUDING THE SAME

(71) Applicant: Samsung Electronics Co., Ltd., Suwon-si (KR)

(72) Inventors: Doohyun Yang, Suwon-si (KR); Dooseok Choi, Suwon-si (KR); Youngki Lee, Suwon-si (KR); Seungyoon Jung, Suwon-si (KR); Woncheol Jeong, Suwon-si (KR); Dongkwon Choi, Suwon-si (KR); Joonhoi Hur, Suwon-si (KR)

(73) Assignee: Samsung Electronics Co., Ltd., Suwon-si (KR)

(21) Appl. No.: 18/371,174

(22) Filed: Sep. 21, 2023

(30) Foreign Application Priority Data
Apr. 20, 2023 (KR) 10-2023-0052236

(51) Int. Cl. H01Q 1/48; H01Q 1/22; H01Q 9/04

(52) U.S. Cl. CPC H01Q 1/48; H01Q 1/2283; H01Q 9/0414

(57) ABSTRACT

An antenna module is provided. The antenna module includes: antenna module including: a ground layer; and an antenna structure on the ground layer and including: a plurality of layers including a first layer, a second layer and a third layer, wherein the second layer and the third layer are between the ground layer and the first layer; one or more vias extending through at least a portion of the plurality of layers; a radiating element in the first layer, a first stub in the second layer and extending from the one or more vias; and a second stub in the third layer and extending from the one or more vias.

### CROSS-REFERENCE TO RELATED APPLICATION

This application claims priority to Korean Patent Application No. 10-2023-0052236, filed on Apr. 20, 2023, in the Korean Intellectual Property Office, the disclosure of which is incorporated by reference herein in its entirety.

### BACKGROUND

Embodiments relate to an antenna module and a device including the antenna module.

With the development of information technology (IT), various types of electronic devices, such as a smartphone, a tablet personal computer, and the like, are being widely supplied. An electronic device communicates wirelessly with another device or a base station using an antenna module.

The recent surge in network traffic caused by the electronic devices has led to the development of 5^{th} generation (5G) new radio (NR) technology and the ongoing development of 6^{th} generation (6G) technology. The 5G technology uses Frequency Range 1 (FR1) and Frequency Range 2 (FR2) frequency bands, and the FR2 bands are defined as frequency bands of about 6 GHz or higher, and include a millimeter wave (mmWave) band that is from approximately 24 GHz to approximately 100 GHz.

### SUMMARY

One or more embodiments provide an antenna module capable of filtering a harmonic component and a device including the antenna module.

According to an aspect of an embodiment, an antenna module including: a ground layer; and an antenna structure on the ground layer and including: a plurality of layers including a first layer, a second layer and a third layer, wherein the second layer and the third layer are between the ground layer and the first layer; one or more vias extending through at least a portion of the plurality of layers; a radiating element in the first layer; a first stub in the second layer and extending from the one or more vias; and a second stub in the third layer and extending from the one or more vias.

According to an aspect of an embodiment, an antenna module including: a ground layer including a plurality of ports; and an antenna structure on the ground layer and including: a plurality of layers including a first layer, a second layer and a third layer, wherein the second layer and the third layer are between the ground layer and the first layer; one or more vias extending through at least a portion of the plurality of layers; a radiating element in the first layer; a first stub in the second layer and extending from the one or more vias; and a second stub in the third layer and extending from the one or more vias, wherein the one or more vias are connected to at least one of the plurality of ports.

According to an aspect of an embodiment, a device includes: a radio frequency integrated circuit (RFIC) configured to process a transmission signal; and an antenna module configured to transmit the transmission signal. The antenna module includes: a ground layer configured to transmit the transmission signal provided from the RFIC to the antenna module; and an antenna structure stacked on the ground layer and including: a plurality of layers including a first layer, a second layer and a third layer, wherein the second layer and the third layer are between the ground layer and the first layer: one or more vias extending through at least a portion of the plurality of layers; a radiating element in the first layer; a first stub in the second layer and extending from the one or more vias; and a second stub in the third layer and extending from the one or more vias.

According to above, the antenna module capable of filtering the harmonic component and the device including the antenna module are provided.

### BRIEF DESCRIPTION OF DRAWINGS

The above and other objects and features will be more clearly understood from the following description, taken in conjunction with the accompanying drawings, in which:

FIG. 1 is a view illustrating an antenna module according to an embodiment;

FIG. 2 is a view illustrating an antenna module according to an embodiment;

FIG. 3 is a plan view of the antenna module of FIG. 2;

FIG. 4 is a view illustrating an antenna module according to an embodiment;

FIG. 5 is a plan view of the antenna module of FIG. 4;

FIG. 6 is a view illustrating an antenna module according to an embodiment;

FIG. 7 is a lateral view of the antenna module of FIG. 6;

FIG. 8 is a view illustrating a stub according to an embodiment;

FIG. 9 is a view illustrating a current distribution of a harmonic component of an antenna module according to an embodiment;

FIG. 10 is a graph illustrating S-parameters of antenna modules according to embodiments;

FIG. 11 is a Smith chart of the S-parameters of FIG. 11;

FIG. 12 is a graph illustrating a distribution of radiated power as a function of a frequency according to an embodiment;

FIG. 13 is a block diagram illustrating an electronic device according to an embodiment; and

FIG. 14 is a block diagram illustrating a device according to an embodiment.

### DETAILED DESCRIPTION

Embodiments will now be described more fully with reference to the accompanying drawings, in which example embodiments are shown. Embodiments described herein are example embodiments, and thus, the present disclosure is not limited thereto, and may be realized in various other forms. Each embodiment provided in the following description is not excluded from being associated with one or more features of another example or another embodiment also provided herein or not provided herein but consistent with the present disclosure. It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to” or “directly coupled to” another element or layer, there are no intervening elements or layers present.

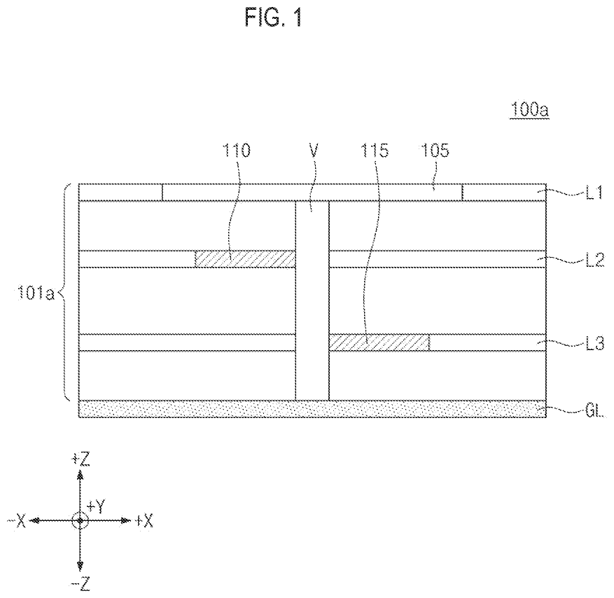

FIG. 1 is a view illustrating an antenna module 100a according to an embodiment.

The antenna module 100a may be a module configured to communicate a radio frequency (RF) signal with an electronic device, such as a base station. As an example, when 5G technology is supported, the antenna module 100a may be configured to transmit and receive the RF signal having a millimeter wave (mmWave) band (about 24 GHz to about 100 GHz).

Referring to FIG. 1, the antenna module 100a may include a ground layer GL and an antenna structure 101a.

The ground layer GL may serve as a ground for the antenna structure 101a. The ground layer GL may be configured to feed a transmission signal (e.g., an RF transmission signal) processed by a communication circuit, e.g., a radio frequency integrated circuit (RFIC), to the antenna structure 101a. Accordingly, the ground layer GL may be referred to as a feed structure. The ground layer GL may include a plurality of layers L1, L2, and L3 for the feeding of the transmission signal.

The antenna structure 101a may be disposed on the ground layer GL. The antenna structure 101a may be configured to radiate the transmission signal fed from the ground layer GL. The antenna structure 101a may include the layers L1, L2, and L3, a via V, a radiating element 105, and a plurality of stubs 110 and 115.

The layers L1, L2, and L3 may be stacked on the ground layer GL along a predetermined direction, e.g., a positive Z direction (hereinafter, referred to as +Z direction). As an example, a third layer L3, a second layer L2, and a first layer L1 may be sequentially stacked on the ground layer GL. In this case, the second layer L2 and the third layer L3 may be disposed between the first layer L1 and the ground layer GL. Insulators may be provided between the layers L1, L2, and L3.

According to an embodiment, the first layer L1 may include the radiating element 105, the second layer L2 may include a first stub 110, and the third layer L3 may include a second stub 115.

The via V may be formed to extend through at least a portion of the layers L1, L2, and L3. One or more vias V may be included in the antenna structure 101a according to various embodiments. The via V may serve as a conductive passage to feed the transmission signal fed from the ground layer GL to other components connected to the via V. Accordingly, the via V may be electrically connected to components respectively included in the layers L1, L2, and L3, e.g., the radiating element 105, the first stub 110, and the second stub 115, for the feeding.

As shown in FIG. 1, the via V may be formed to extend from the ground layer GL in a vertical direction, e.g., the +Z direction.

The radiating element 105 may be included in the first layer L1. The radiating element 105 may receive the transmission signal fed from the ground layer GL through the via V and may radiate the transmission signal fed thereto. As an example, the radiating element 105 may be configured to receive the transmission signal having an ultra-high frequency band, for example, about 6 GHz to about 100 GHz, to be used for wireless communication with other devices from the via V and may radiate the received transmission signal. For example, the radiating element 105 may be implemented in various shapes to radiate the transmission signal, such as a dipole, a monopole, a slot, or a loop shape, as well as the illustrated patch shape.

One or more radiating elements 105 may be provided according to various embodiments. In some embodiments, plural radiating elements 105 may be provided, and the radiating elements may transmit or receive the RF signals with different ultra-high frequency bands from each other.

The stubs 110 and 115 may be configured to provide an impedance matching between the antenna module 100a and other components connected to the antenna module 100a, and to filter a harmonic component included in the transmission signal.

The stubs 110 and 115 may be included in the second and third layers L2 and L3 except the first layer L1 among the layers L1, L2, and L3. As an example, the stubs 110 and 115 may include the first stub 110 and the second stub 115 as shown in FIG. 1.

The first stub 110 may be included in the second layer L2, and the second stub 115 may be included in the third layer L3. That is, the first stub 110 and the second stub 115 may be provided in different layers from each other. When compared with a case where the first stub 110 and the second stub 115 are provided in the same layer, the first stub 110 and the second stub 115, which are provided in different layers from each other, may have different paths from the ground layer GL. Accordingly, the antenna module 100a according to embodiments may have a degree of freedom in setting the band to secure the impedance matching.

According to an embodiment, the first stub 110 may be formed to extend from the via V, and the second stub 115 may be formed to extend from the via V. As an example, the first stub 110 may extend from the via V in a first direction, e.g., a negative X direction (hereinafter, referred to as −X direction), and the second stub 115 may extend from the via V in a second direction different from the first direction, e.g., a positive X direction (hereinafter, referred to as +X direction). As an example, each of the first stub 110 and the second stub 115 may be a shunt stub extending in a direction perpendicular to the direction, e.g., the +Z direction, in which the via V is formed. According to an embodiment, the first stub 110 and the second stub 115 may extend from the via V in the same or different directions within the layers where the first and second stubs 110 and 115 are respectively located, i.e., within the second layer L2 and the third layer L3.

Each of the first and second stubs 110 and 115 may have a bar shape as shown in FIG. 1, however, according to embodiments, the first and second stubs 110 and 115 may have a variety of shapes to provide the impedance matching and to filter the harmonic component.

The stubs 110 and 115 may have a micro-strip line structure or a strip line structure.

FIG. 1 shows two stubs 110 and 115 as a representative example of the stubs, however, embodiments are not limited thereto. According to an embodiment, in a case where additional layers are provided between the first layer L1 and the ground layer GL, the number of the stubs may increase.

Each of the stubs 110 and 115 may be configured to filter the harmonic component with respect to fundamental frequency components included in the transmission signal. That is, the stubs 110 and 115 may resonate the harmonic component to be filtered. When f is the fundamental frequency components, the harmonic component may be n times f (n is a natural number). The harmonic component may be included in the RF signal amplified by the communication circuit connected to the antenna module 100a. In a case where the harmonic component is radiated through the radiating element 105, this may be regarded as an unnecessary emission, e.g., spurious waves, and thus, the transmission signal may include noise and violate communication regulations.

As an example, when the antenna module 100a is configured to transmit signals in n260 or n259 band in the FR2 band supported by 5G as shown in Table 1 below, the harmonic component, such as about 80 GHz and about 120 GHz, corresponding to n times the fundamental frequency components, about 40 GHz, may occur.

TABLE 1

| | NR operating Band Uplink and |
|---|---|
| Band number | Downlink Frequency Range |
| n257 | 26.5 GHz-29.5 GHz |
| n258 | 24.25 GHz-27.5 GHz |
| n259 | 39.5 GHz-43.5 GHz |
| n260 | 37 GHz-40 GHz |
| n261 | 27.5 GHz-28.35 GHz |
| n262 | 47.2 GHz-48.2 GHz |
| n263 | 57 Hz-71 GHz |

When the harmonic component is included in the transmission signal in the above FR2 bands, a resonance corresponding to a corresponding harmonic component may occur in the antenna module 100a. The resonance corresponding to the harmonic component may appear as characteristics corresponding to a horizontal polarization or a vertical polarization at each port of the antenna module 100a.

According to an embodiment, at least one of a width and a length of each of the stubs 110 and 115 may be set to filter the resonance corresponding to a harmonic component. In particular, the length of each of the stubs 110 and 115 may correspond to a parameter that has a relatively greater effect on filtering a harmonic component. Accordingly, the length of each of the first stub 110 and the second stub 115 may be set to correspond to a guided wavelength associated with the harmonic component according to various embodiments. As an example, the length of each of the first stub 110 and the second stub 115 may be set to correspond to one-fourth (¼) of a corresponding guided wavelength.

According to an embodiment, at least one of the widths and the lengths of the stubs 110 and 115 may be set to be the same as each other or different from each other depending on the harmonic component to be filtered by the stubs 110 and 115. As an example, the first stub 110 may be configured to filter an n^{th} harmonic component (n is a natural number equal to or greater than 2) included in the transmission signal, and the second stub 115 may be configured to filter an (n+a)^{th} harmonic component (a is a whole number equal to or greater than zero) included in the transmission signal. Accordingly, the first stub 110 and the second stub 115 may be configured to filter the same harmonic component or may be configured to filter different harmonic components.

In addition, as the width and the length of each of the stubs 110 and 115 are set, the impedance matching in a specific band may be performed together with the filtering of the harmonic component. As an example, at least one of the width and the length of each of the stubs 110 and 115 may be set to allow an input impedance of the antenna module 100a to correspond to an optimal load to be designed.

Accordingly, as the stubs 110 and 115 disposed on different layers from each other are added to the via V for the feeding operation, the impedance matching and the filtering of a specific harmonic component may be performed together. Accordingly, the antenna module 100a according to embodiments may suppress the harmonic component that is targeted to be limited to less than a communication standard in the RF signal. Particularly, embodiments may have advantages in that the suppression of the harmonic component is performed not in the communication circuit, such as the RFIC connected to the antenna module 100a, but in the antenna module 100a. In addition, as the stubs 110 and 115 are disposed on different layers from each other, each stub may filter different harmonic components from each other as well as the same harmonic component as each other, and thus, there is an advantage in that the filter characteristics may be broadened.

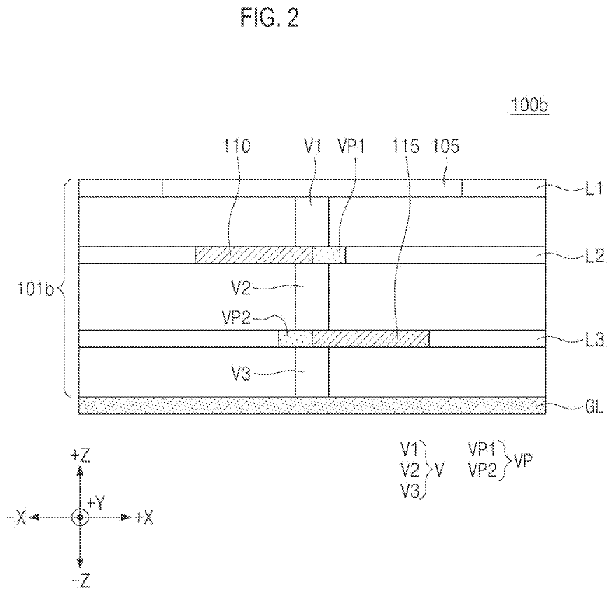

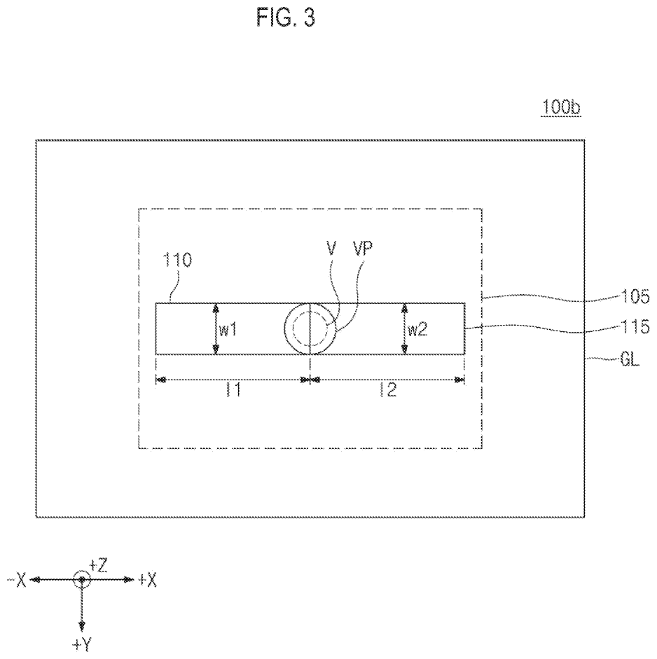

FIG. 2 is a view illustrating an antenna module 100b according to an embodiment, and FIG. 3 is a plan view of the antenna module of FIG. 2. In FIGS. 2 and 3, the same reference numerals denote the same or similar elements in FIG. 1, and thus, detailed descriptions of the same or similar elements may be omitted.

Referring to FIGS. 2 and 3, the antenna module 100b may include a ground layer GL and an antenna structure 101b. The antenna structure 101b may include a plurality of layers L1, L2, and L3, a plurality of vias V, a plurality of via pads VP, a radiating element 105, and a plurality of stubs 110 and 115.

The vias V may feed a transmission signal provided from the ground layer GL to the radiating element 105. According to an embodiment, the vias V may be formed through at least a portion of the layers L1, L2, and L3. The vias V may include a first via V1, a second via V2, and a third via V3. As an example, the first via V1 may extend through at least one of a first layer L1 and a second layer L2, the second via V2 may extend through at least one of the second layer L2 and a third layer L3, and the third via V3 may extend through at least one of the third layer L3 and the ground layer GL. The vias V may extend through insulators disposed between the layers L1, L2, and L3.

Each of the vias V may be disposed in various ways between the layers L1, L2, and L3 and a ground as long as the vias are connected to at least a portion of the layers L1, L2, and L3 and the ground layer GL. As an example, the first via V1, the second via V2, and the third via V3 may be disposed to extend through at least the portion of the layers L1, L2, and L3 and the ground layer GL along a predetermined direction, e.g., the −X direction or the +X direction.

The via pads VP may include a first via pad VP1 and a second via pad VP2. The first via pad VP1 may be disposed at the second layer L2, and the second via pad VP2 may be disposed at the third layer L3. Each of the via pads VP may be provided on an outer circumference of a corresponding via. As an example, each of the via pads VP may have a closed-loop shape.

The stubs 110 and 115 may be connected to the via pads VP. One end of each of the stubs 110 and 115 may be connected to a portion of the via pads VP, and the other end of each of the stubs 110 and 115 may extend from the via pads VP. As an example, the one end of the first stub 110 may extend from the first via pad VP1 in the first direction, e.g., the −X direction, and the other end of the second stub 115 may extend from the second via pad VP2 in the second direction, e.g., the +X direction, different from the first direction. As an example, each of the first stub 110 and the second stub 115 may be a shunt stub extending in a direction perpendicular to the direction, e.g., the +Z direction, in which the via V is formed.

At least one of a width and a length of each of the stubs 110 and 115 may be set to provide an impedance matching between the antenna module 100b and other components connected to the antenna module 100b, and to filter a harmonic component included in the transmission signal.

According to an embodiment, at least one of a width w1 and a length l1 of the first stub 110 may be set to allow the first stub 110 to filter a specific harmonic component. At least one of a width w2 and a length l2 of the second stub 115 may be set to allow the second stub 115 to filter a harmonic component that is the same as or different from the harmonic component filtered by the first stub 110.

As an example, in a case where the first stub 110 is configured to filter an n^{th} harmonic component, the length l1 of the first stub 110 may correspond to one-fourth (¼) of the guided wavelength of the n^{th} harmonic component. As an example, in a case where the second stub 115 is configured to filter an (n+a)^{th} harmonic component, the length l2 of the second stub 115 may correspond to one-fourth (¼) of the guided wavelength of the (n+a)^{th} harmonic component.

In addition, at least one of the width w1 and the length l1 of the first stub 110, and the width w2 and the length l2 of the second stub 115, may be set to filter the harmonic component and to provide the impedance matching. In this case, when the first stub 110 having the length l1 and the second stub 115 having the length l2 are viewed from the ground layer GL, there is a difference in path between each of the first and second stubs 110 and 115 and the ground layer GL. Accordingly, the antenna module 100b according to embodiments may have a degree of freedom in setting of the band to secure the impedance matching due to the first stub 110 and the second stub 115, which are located on different layers from each other and have the lengths l1 and l2 set to be the same as each other or different from each other

According to embodiments, as the stubs 110 and 115 extending from the vias V and the via pads VP are added in the form of a shunt, the impedance matching may be provided, and the harmonic component may be filtered. In particular, because the width and the length of each of the stubs 110 and 115 may be set while the stubs 110 and 115 are located on different layers from each other, the antenna module 100b according to embodiments has a degree of freedom in impedance matching and a degree of freedom in the design of filter characteristics for the harmonic component. As an example, the stubs 110 and 115 may overlap similar bands depending on the design, enabling the broadening of the characteristics of a harmonic filter.

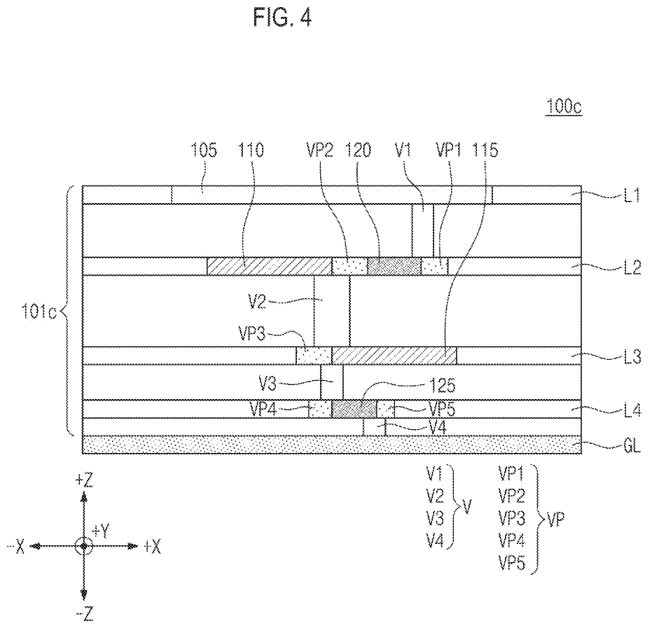

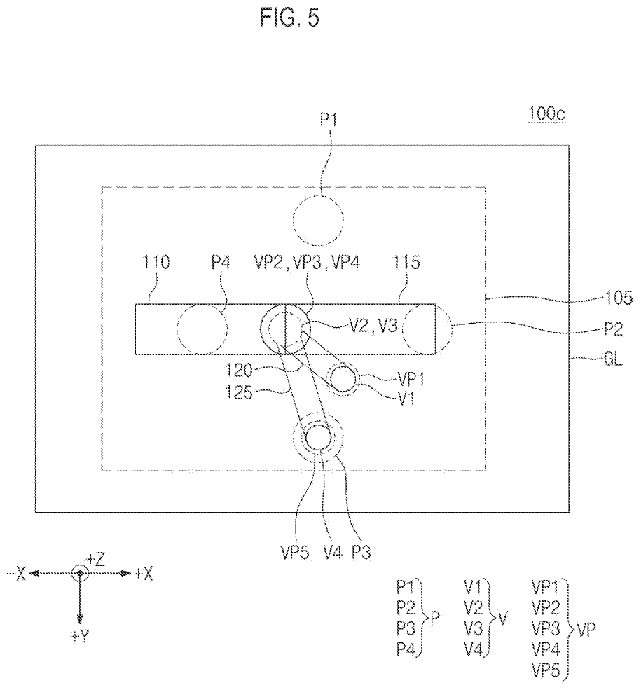

FIG. 4 is a view illustrating an antenna module 100C according to an embodiment, and FIG. 5 is a plan view of the antenna module of FIG. 4.

Referring to FIGS. 4 and 5, the antenna module 100c may include a ground layer GL and an antenna structure 101c. The antenna structure 101c may include a plurality of layers L1 to L4, a plurality of vias V, a plurality of via pads VP, a plurality of feed lines 120 and, 125, a plurality of ports P, a radiating element 105, and a plurality of stubs 110 and 115.

The layers L1 to L4 may include first, second, third, and fourth layers L1, L2, L3, and L4. The first to fourth layers L1 to L4 may be stacked on the ground layer GL in a predetermined direction, e.g., the +Z direction. As an example, the fourth layer L4, the third layer L3, the second layer L2, and the first layer L1 may be sequentially stacked on the ground layer GL. Insulators may be disposed between the layers L1 to L4.

The second layer L2 may include a first feed line 120, and the fourth layer L4 may include a second feed line 125.

The vias V may include first, second, third, and fourth vias V1, V2, V3, and V4. As an example, the first via V1 may extend through at least one of the first layer L1 and the second layer L2, the second via V2 may extend through at least one of the second layer L2 and the third layer L3, and the third via V3 and the fourth via V4 may extend through at least one of the third layer L3 and the ground layer GL. The vias V may extend through the insulators disposed between the layers L1 to L4.

The via pads VP may include first, second, third, fourth, and fifth via pads VP1, VP2, VP3, VP4, and VP5. The first via pad VP1 and the second via pad VP2 may be disposed in the second layer L2, the third via pad VP3 may be disposed in the third layer L3, and the fourth via pad VP4 and the fifth via pad VP5 may be disposed in the fourth layer L4. Each of the via pads VP may be provided on an outer circumference of a corresponding via.

The first via pad VP1 may be provided to surround an outer circumference of one end of the first via V1, the second via pad VP2 may be provided to surround an outer circumference of the other end of the second via V2, the third via pad VP3 may be provided to surround an outer circumference of one end of the second via V2 or an outer circumference of the other end of the third via V3, the fourth via pad VP4 may be provided to surround an outer circumference of one end of the third via V3, and the fifth via pad VP5 may be provided to surround an outer circumference of the other end of the fourth via V4.

The feed lines 120 and 125 may include the first feed line 120 and the second feed line 125. The first feed line 120 may be disposed in the second layer L2 and may be connected between the first via pad VP1 and the second via pad VP2. The second feed line 125 may be disposed in the fourth layer L4 and may be connected between the fourth via pad VP4 and the fifth via pad VP5. The second feed line 125 may be connected to at least one of the ports P formed on the ground layer GL via the fourth via V4.

Each of the feed lines 120 and 125 may serve as a conductive passage to feed a transmission signal provided from the ground layer GL to each via. As an example, the first feed line 120 may feed the transmission signal provided from the second via V2 to the radiating element 105 through the first via V1, and the second feed line 125 may feed the transmission signal provided from the fourth via V4 through the third via V3.

The ports P may include first, second, third, and fourth ports P1, P2, P3, and P4. The ports P may be formed on the ground layer GL. At least a portion of the ports P may be configured to transmit a signal of a specific band from a communication circuit to the radiating element 105. In embodiments where the radiating element 105 is provided in plural, at least a portion of the ports P may transmit a signal of a first band to one of the radiating elements 105, and at least another portion of the ports P may transmit a signal of a second band to another element of the radiating elements 105. As an example, the third port P3 of FIG. 5 may be connected to the fourth via V4 and may transmit the transmission signal of the specific band, which is provided from the ground layer GL, to the fourth via V4.

The stubs 110 and 115 may be connected to the via pads VP. One end of each of the stubs 110 and 115 may be connected to a portion of the via pads VP, and the other end of each of the stubs 110 and 115 may extend from the via pads VP. As an example, the one end of the first stub 110 may extend from the second via pad VP2 in the first direction, e.g., the −X direction, and the other end of the second stub 115 may extend from the third via pad VP3 in the second direction, e.g., the +X direction, which is different from the first direction. As an example, each of the first stub 110 and the second stub 115 may be a shunt stub extending in a direction perpendicular to the direction, e.g., the +Z direction, in which the via V is formed.

According to various embodiments, at least one of a width and a length of each of the stubs 110 and 115 may be set to provide an impedance matching between the antenna module 100c and other components connected to the antenna module 100c and to filter a harmonic component included in the transmission signal.

As an example, in embodiments where at least one of the width and the length of each of the stubs 110 and 115 is set to filter a specific harmonic component, among the transmission signals primarily transmitted from the ground layer GL to the third layer L3 through the second feed line 125, a specific harmonic component may flow into the second stub 115. This is because the second stub 115 acts as a resonator for a specific harmonic. Then, the specific harmonic component may be transmitted to the second layer L2 through the second via V2, and the transmitted specific harmonic component may flow into the first stub 110. This is because the first stub 110 also acts as a resonator for the specific harmonic. As a result, the harmonic component included in the transmission signal may be filtered by the first stub 110 and the second stub 115 when fed to the radiating element 105.

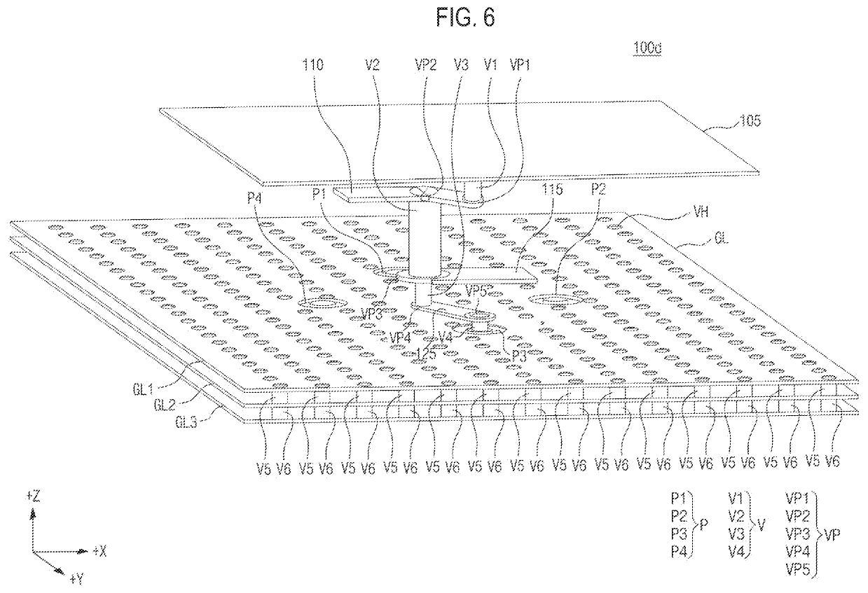

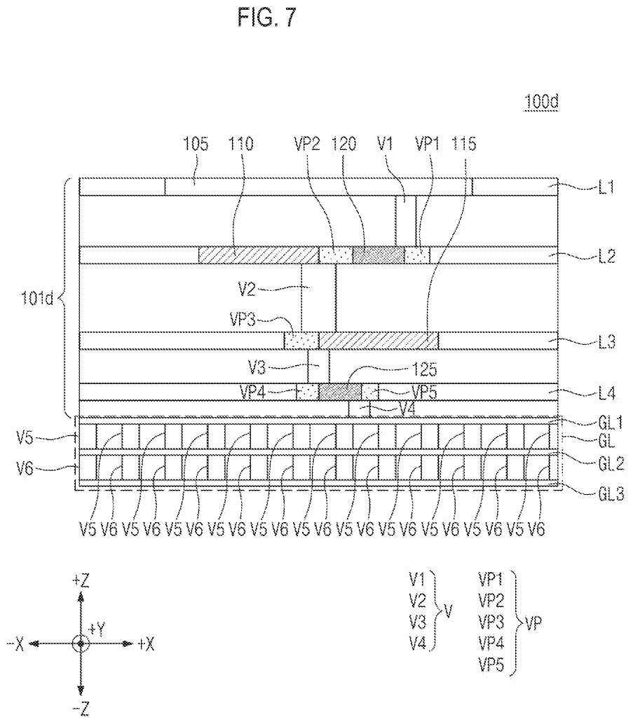

FIG. 6 is a view illustrating an antenna module 100d according to an embodiment, and FIG. 7 is a lateral view of the antenna module 100d of FIG. 6.

Referring to FIGS. 6 and 7, the antenna module 100d may include a ground layer GL and an antenna structure 101d. The antenna structure 101d may include a plurality of layers L1 to L4, a plurality of vias V, a plurality of via pads VP, a plurality of feed lines 120 and 125, a plurality of ports P, a radiating element 105, and a plurality of stubs 110 and 115.

The ground layer GL may include first, second, and third ground layers GL1, GL2, and GL3. The first to third ground layers GL1 to GL3 may include a plurality of fifth vias V5, a plurality of sixth vias V6, and a plurality of via holes VH in which the fifth vias V5 and the sixth vias V6 are formed.

Each of the fifth vias V5 and each of the sixth vias V6 may be configured to feed a transmission signal processed by a communication circuit to the antenna structure 101d. Accordingly, different from the antenna module 100d shown in FIG. 6, the ground layer GL may include various elements to feed the transmission signal to the antenna structure 101d in addition to the first to third ground layers GL1 to GL3, the fifth vias V5, and the sixth vias V6. According to an embodiment, at least one of the first to third ground layers GL1 to GL3, the fifth vias V5, and the sixth vias V6 may be omitted.

Insulators may be disposed between the first to third ground layers GL1 to GL3. The fifth vias V5 may be connected to the via hole VH extending through the insulator between the first ground layer GL1 and the second ground layer GL2, and the sixth vias V6 may be connected to the via hole VH extending through the insulator between the second ground layer GL2 and the third ground layer GL3.

The fifth vias V5 and the sixth vias V6 may feed the transmission signal provided thereto from the communication circuit to at least one port of the ports P through the third ground layer GL3, the second ground layer GL2, and the first ground layer GL1. As an example, in embodiments where a fourth via V4 is connected to a third port P3 as shown in FIG. 6, the transmission signal fed through the fifth vias V5 and the sixth vias V6 may be fed to the radiating element 105 through the third port P3 and the fourth via V4.

The transmission signal fed from the ground layer GL may be transmitted to the fourth layer L4 through the fourth via V4 and may be transmitted to the third layer L3 through a second feed line 125 included in the fourth layer L4 after passing through a third via V3. In addition, the transmission signal may be transmitted to the second layer L2 through a second via V2 and may be transmitted to the radiating element 105 included in the first layer L1 through a first feed line 120 included in the second layer L2 after passing through a first via V1.

The stubs 110 and 115 may be connected to the via pads VP. One end of each of the stubs 110 and 115 may be connected to a portion of the via pads VP, and the other end of each of the stubs 110 and 115 may extend from the via pads VP. As an example, the one end of a first stub 110 may extend from a second via pad VP2 in a first direction, and the other end of a second stub 115 may extend from a third via pad VP3 in a second direction different from the first direction.

According to various embodiments, at least one of a width and a length of each of the stubs 110 and 115 may be set to provide an impedance matching between the antenna module 100d and other components connected to the antenna module 100d, and to filter a harmonic component included in the transmission signal.

As an example, in embodiments where at least one of the width and the length of each of the stubs 110 and 115 is set to filter a specific harmonic component, among the transmission signals primarily transmitted from the ground layer GL to the third layer L3 through the second feed line 125, a specific harmonic component may flow into the second stub 115. Then, the specific harmonic component may be transmitted to the second layer L2 through the second via V2, and the transmitted specific harmonic component may flow into the first stub 110. As a result, the harmonic component included in the transmission signal may be filtered by the first stub 110 and the second stub 115 when fed to the radiating element 105.

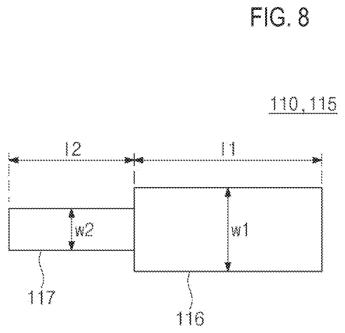

FIG. 8 is a view illustrating stubs 110 and 115 according to an embodiment.

The stubs 110 and 115 according to the various embodiments may have a variety of shapes rather than the bar shape to provide the impedance matching and to filter the harmonic component, and as an example, the stubs 110 and 115 may have a T-shape as shown in FIG. 8. The stubs 110 and 115 each having the T-shape may each include sub-stubs 116 and 117 that differ from each other in at least one of a width and a length. As an example, a first stub 110 may include a first-first sub-stub and a first-second sub-stub, which have different widths from each other, and a second stub 115 may include a second-first sub-stub and a second-second sub-stub, which have different widths from each other.

According to an embodiment, at least one of a width w1 and a length l1 of one sub-stub 116 may be set to allow the sub-stub 116 to filter a specific harmonic component. At least one of a width w2 and a length l2 of the other sub-stub 117 may be set to allow the sub-stub 117 to filter the same harmonic component as or different harmonic component from the harmonic component filtered by the sub-stub 116.

In addition, the width w1 and the length l1 of the one sub-stub 116 and the width w2 and the length l2 of the other sub-stub 117 may be set to provide the impedance matching together with the filtering of the harmonic component.

As an example, in a case where the one sub-stub 116 is configured to filter an n^{th} harmonic component, the length l1 of the one sub-stub 116 may correspond to one-fourth (¼) of the guided wavelength of the n^{th} harmonic component. As an example, in a case where the other sub-stub 117 is configured to filter an (n+a)^{th} harmonic component, the length l2 of the other sub-stub 117 may correspond to one-fourth (¼) of the guided wavelength of the (n+a)^{th} harmonic component.

According to embodiments, the stub extending from the via may have a structure including several sub-stubs, and in this case, several harmonic components may be filtered even within the stub included in one layer.

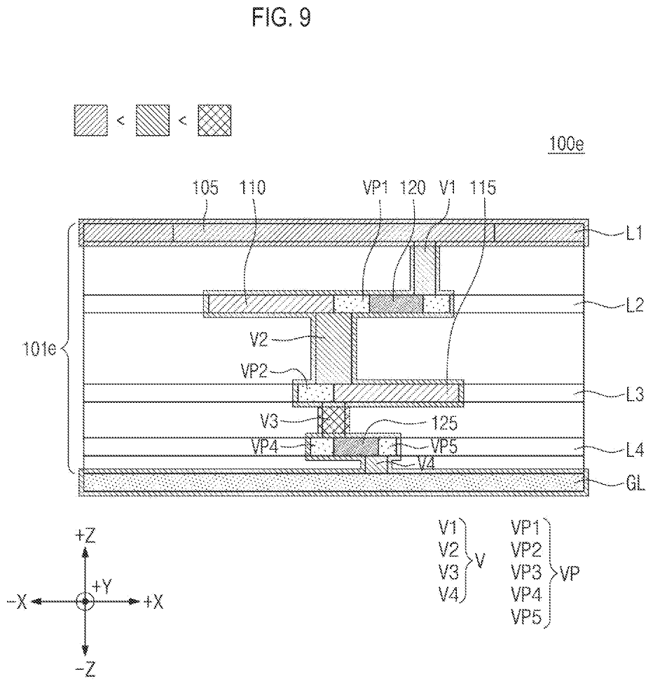

FIG. 9 is a view illustrating a current distribution of a harmonic component of an antenna module 100e according to an embodiment.

Referring to FIG. 9, in a case where a plurality of stubs 110 and 115 extends from one or more vias V included in the antenna module 100e, and each of the stubs 110 and 115 is configured to filter a specific harmonic component, each of the stubs 110 and 115 may serve as a resonator corresponding to the harmonic component to be filtered. Accordingly, when the harmonic component included in a transmission signal is transmitted from a ground layer GL to an antenna structure 101e in the form of current, it may be observed that the current is distributed not only to a radiating element 105 but also to the stubs 110 and 115.

Particularly, because the stubs 110 and 115 may serve as resonators for harmonic components, a current distributed in the radiating element 105 located in the first layer L1, which is located higher than a layer where a first stub 110 and a second stub 115 are located, may be lower than that in the first stub 110 and the second stub 115. As a result, because the harmonic component is filtered by the stubs 110 and 115 while being transmitted from the ground layer GL to the radiating element 105, the harmonic component included in the transmission signal radiated to the outside by the radiating element 105 may be minimized.

In addition, at least one of a width and a length of each of the stubs 110 and 115 may be set to filter different harmonic components from each other according to various embodiments, and in this case, the current distribution for the specific harmonic component may appear different for each of the stubs 110 and 115.

Accordingly, as the stubs 110 and 115 located on different layers are added to the vias for the feeding operation, the harmonic component to be limited to less than a communication standard in the transmission signal radiated from the radiating element 105 may be suppressed.

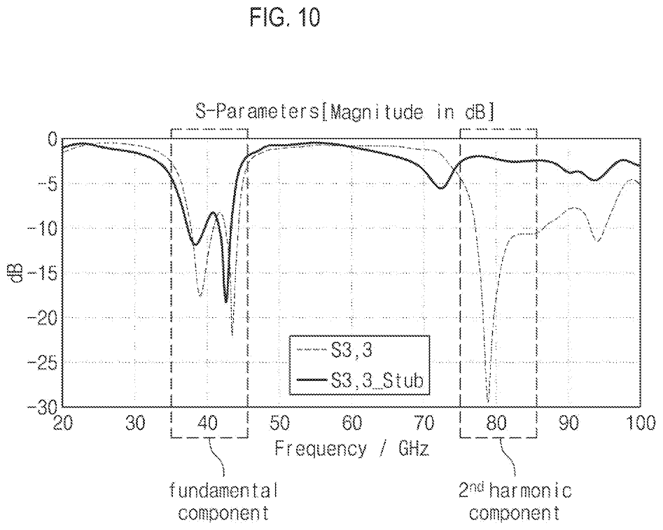

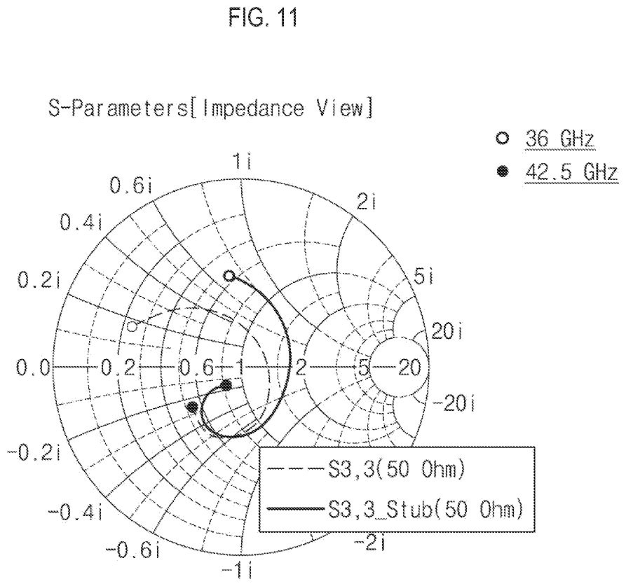

FIG. 10 is a graph illustrating S-parameters of antenna modules according to embodiments, and FIG. 11 is a Smith chart of the S-parameters of FIG. 11.

Referring to FIG. 10, different from the antenna modules 100a to 100e, when the stubs 110 and 115 do not exist in the antenna module, the resonance characteristics in which a reflection parameter for a specific port is rapidly changed may be observed not only in a fundamental frequency but also in a harmonic frequency band. As an example, in a case where the stubs 110 and 115 do not exist when the fundamental frequency is about 40 GHz as shown in FIG. 10, the resonance characteristics are observed at a frequency of about 80 GHz that is a second harmonic component. On the other hand, when the stubs 110 and 115 whose width and length are set to filter the harmonic component are provided according to embodiments, the resonance characteristics are observed only in the fundamental frequency. As an example, when the transmission signal of n260 or n259 band of Table 1 is transmitted, the antenna modules 100a to 100e according to embodiments may comply with the communication regulations by filtering the frequency of about 80 GHz, which is the second-order harmonic component for the n260 or n259 band.

In addition, it is observed that the matching of a specific impedance, e.g., about 50 ohms, is possible in the band, e.g., about 36 GHz to about 42.5 GHZ, of the transmission signal regardless of the presence or absence of the stub as shown in FIG. 11. In addition, because at least one of the width and the length of the stub may be adjusted, it is also possible to match the impedance to an advantageous value in terms of design.

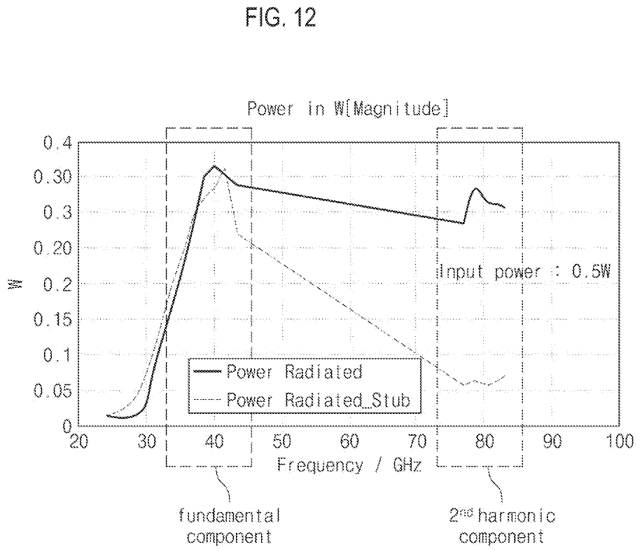

FIG. 12 is a graph illustrating a distribution of radiated power as a function of a frequency according to an embodiment.

Referring to FIG. 12, assuming that an input power for the antenna is constant, e.g., about 0.5 W, in embodiments where the stubs 110 and 115 do not exist, it is observed that a relatively high power is radiated not only in the fundamental frequency band, but also in the harmonic component band.

On the other hand, in embodiments where the stubs 110 and 115 are configured to filter the specific harmonic component according to embodiments, it is observed that a relatively low power is radiated in the harmonic component band unlike the fundamental frequency band. Accordingly, it is observed that the stubs 110 and 115 operate as a filter for the specific harmonic component in terms of a power of the radiation wave.

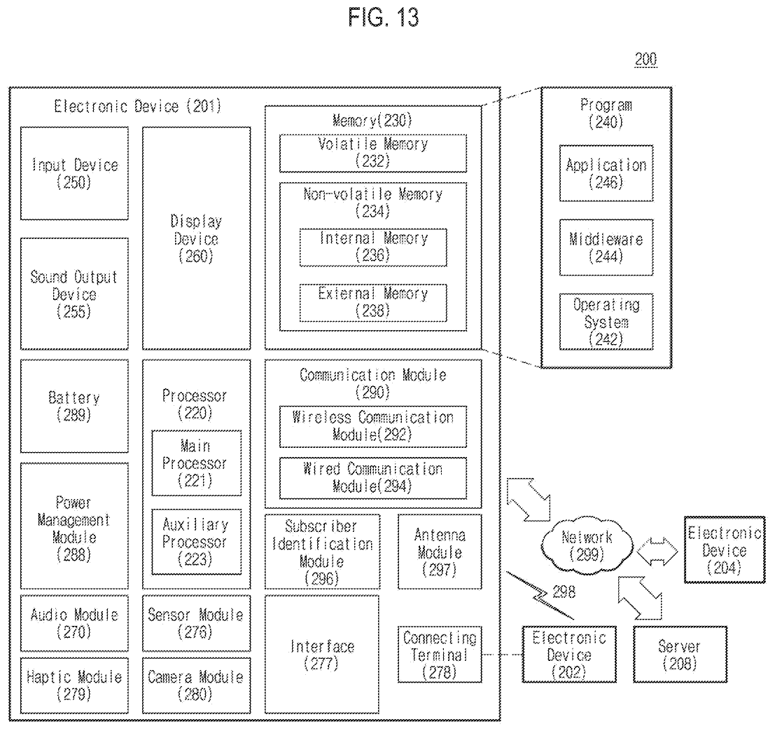

FIG. 13 is a block diagram illustrating an electronic device according to an embodiment.

Referring to FIG. 13, an electronic device 201 in a network environment 200 may communicate with an electronic device 202 via a first network 298 or may communicate with an electronic device 204 or a server 208 via a second network 299.

According to an embodiment, the electronic device 201 may communicate with the electronic device 204 via the server 208. According to an embodiment, the electronic device 201 may include a processor 220, a memory 230, an input device 250, a sound output device 255, a display device 260, an audio module 270, a sensor module 276, an interface 277, a haptic module 279, a camera module 280, a power management module 288, a battery 289, a communication module 290, a subscriber identification module 296, or an antenna module 297. According to an embodiment, at least one (e.g., the display device 260 or the camera module 280) of the components may be omitted from the electronic device 201, or one or more other components may be added in the electronic device 201. According to an embodiment, some of the components may be implemented as single integrated circuitry. For example, the sensor module 276 (e.g., a fingerprint sensor, an iris sensor, or an illuminance sensor) may be implemented as embedded in the display device 260 (e.g., a display).

The processor 220 may execute, for example, software (e.g., a program 240) to control at least one other component (e.g., a hardware or software component) of the electronic device 201 coupled with the processor 220 and may perform various data processing or computation. According to an embodiment, as at least part of the data processing or computation, the processor 220 may load commands or data received from another component (e.g., the sensor module 276 or the communication module 290) in a volatile memory 232, process the command or the data stored in the volatile memory 232, and store resulting data in a non-volatile memory 234. According to an embodiment, the processor 220 may include a main processor 221 (e.g., a central processing unit (CPU) or an application processor (AP)) and an auxiliary processor 223 (e.g., a graphics processing unit (GPU), an image signal processor (ISP), a sensor hub processor, or a communication processor (CP)) that is operable independently from, or in conjunction with, the main processor 221. Additionally or alternatively, the auxiliary processor 223 may be adapted to consume less power than the main processor 221, or to be specific to a specified function.

The auxiliary processor 223 may be implemented as separate from, or as part of the main processor 221. The auxiliary processor 223 may control at least some of functions or states related to at least one component (e.g., the display device 260, the sensor module 276, or the communication module 290) among the components of the electronic device 201, instead of the main processor 221 while the main processor 221 is in an inactive (e.g., sleep) state, or together with the main processor 221, while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system 242, middleware 244, or an application 246. The input device 250 may receive commands or data to be used by another component (e.g., the processor 220) of the electronic device 201, from the outside (e.g., a user) of the electronic device 201.

The input device 250 may include, for example, a microphone, a mouse, or a keyboard.

The sound output device 255 may output sound signals to the outside of the electronic device 201. The sound output device 255 may include, for example, a speaker or a receiver. The speaker may be used for general purposes, such as playing multimedia or playing a record, and the receiver may be used for incoming calls. According to an embodiment, the receiver may be implemented as separate from, or as part of the speaker.

The display device 260 may visually provide information to the outside (e.g., a user) of the electronic device 201. The display device 260 may include, for example, a display, a hologram device, or a projector and control circuitry to control a corresponding one of the display, hologram device, and projector. According to an embodiment, the display device 260 may include touch circuitry adapted to detect a touch, or sensor circuitry (e.g., a pressure sensor) adapted to measure the intensity of force incurred by the touch.

The audio module 270 may convert a sound into an electrical signal and vice versa. According to an embodiment, the audio module 270 may obtain the sound via the input device 250 or may output the sound via the sound output device 255 or an external electronic device, such as a speaker or a headphone, (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, an HDMI connector, a USB connector, an SD card connector, or an audio connector (e.g., a headphone connector).

The haptic module 279 may convert an electrical signal into a mechanical stimulus (e.g., a vibration or a movement) or electrical stimulus which may be recognized by a user via his/her tactile sensation or kinesthetic sensation. According to an embodiment, the haptic module 279 may include, for example, a motor, a piezoelectric element, or an electric stimulator.

The camera module 280 may capture a still image or a video. According to an embodiment, the camera module 280 may include one or more lenses, image sensors, image signal processors, or flashes.

The power management module 288 may manage power supplied to the electronic device 201. According to an embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the AP) and supports a direct (e.g., wired) communication or a wireless communication.

According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device via the first network 298 (e.g., a short-range communication network, such as Bluetooth™, wireless-fidelity (Wi-Fi) direct, or Infrared Data Association (IrDA)) or the second network 299 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other.

The wireless communication module 292 may identify and authenticate the electronic device 201 in a communication network, such as the first network 298 or the second network 299, using subscriber information (e.g., international mobile subscriber identity (IMSI)) stored in the subscriber identification module 296.

The antenna module 297 may transmit or receive a signal or power to or from the outside (e.g., the external electronic device) of the electronic device 201. According to an embodiment, the antenna module 297 may include a plurality of antennas. At least one antenna appropriate for a communication scheme used in the communication network, such as the first network 298 or the second network 299, may be selected, for example, by the communication module 290 from the plurality of antennas. The signal or the power may then be transmitted or received between the communication module 290 and the external electronic device via the selected at least one antenna.

The antenna module 297 may include the antenna modules 100a, 100b, 100c, 100d, and 100e according to the various embodiments. According to the various embodiments, the antenna module 297 may include the stubs in each of which at least one of the width and the length is set to filter the specific harmonic component. Accordingly, the antenna module 297 may perform the impedance matching function together with the filtering of the harmonic component, and particularly, may suppress the harmonic component that needs to be limited to less than a communication standard in the RF signal.

As an example, as the antenna module 297 includes the stubs, the antenna module 297 may transmit the RF signal from which the harmonic component is filtered to the first network 298 and/or the second network 299.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)). According to an embodiment, commands or data may be transmitted or received between the electronic device 201 and the external electronic device 204 via the server 208 coupled with the second network 299.

Each of the electronic devices 202 and 204 may be a device of a same type as, or a different type from, the electronic device 201. According to an embodiment, all or some of the operations to be executed at the electronic device 201 may be executed at one or more of the external electronic devices 202, 204, or 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, or client-server computing technology may be used, for example.

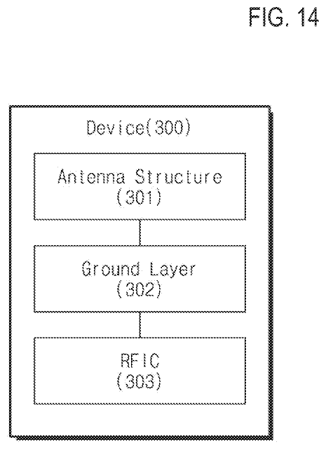

FIG. 14 is a block diagram illustrating a device 300 according to an embodiment.

Referring to FIG. 14, the device 300 may include an antenna structure 301, a ground layer 302, and an RFIC 303.

The antenna structure 301 and the ground layer 302 may be implemented according to the above-described various embodiments. The antenna structure 301 may include the stubs 110 and 115 in each of which at least one of the width and the length is set to filter the specific harmonic component. Accordingly, the antenna structure 301 may perform the impedance matching function together with the filtering of the harmonic component, and particularly, may suppress the harmonic component that needs to be limited to less than a communication standard in the RF signal.

The ground layer 302 may be configured to feed a transmission signal processed by the RFIC 303 to the antenna structure 301.

The RFIC 303 may include a plurality of RF components (e.g., circuits) to process the RF signal that is the transmission signal. As an example, the RFIC 303 may include an amplifier, a mixer, an oscillator, a digital-to-analog converter (DAC), an analog-to-digital converter (ADC), or the like. As an example, the RFIC 303 may process the RF signal to transmit or receive a target signal, and the RF signal processed by the RFIC 303 may be transmitted or received through the ground layer 302 and the antenna structure 301.

In this case, because the stubs 110 and 115 are provided to filter the harmonic component in the antenna structure 301 connected to the RFIC 303 through the ground layer 302, the device 300 may filter the harmonic component even though the RFIC 303 does not include separate RF components to suppress the harmonic component.

While aspects of embodiments have been particularly shown and described, it will be understood that various changes in form and details may be made therein without departing from the spirit and scope of the following claims.

What is claimed is:

1. An antenna module comprising:
a ground layer; and
an antenna structure on the ground layer and comprising:
a plurality of layers comprising a first layer, a second layer and a third layer, wherein the second layer and the third layer are between the ground layer and the first layer;
one or more vias extending through at least a portion of the plurality of layers;
a radiating element in the first layer;
a first stub in the second layer and extending from the one or more vias; and
a second stub in the third layer and extending from the one or more vias.

2. The antenna module of claim 1, wherein the one or more vias are configured to transmit a transmission signal to the radiating element.

3. The antenna module of claim 2, wherein each of the first stub and the second stub is configured to filter a harmonic component of the transmission signal.

4. The antenna module of claim 3, wherein each of the first stub and the second stub has a length corresponding to one-fourth (¼) of a guided wavelength of the harmonic component.

5. The antenna module of claim 1, wherein the first stub extends from the one or more vias in a first direction, and the second stub extends from the one or more vias in a second direction different from the first direction.

6. The antenna module of claim 1, wherein each of the first stub and the second stub has a micro-strip line structure.

7. The antenna module of claim 3, wherein a strength of the harmonic component is lower in the radiating element than in each of the first stub and the second stub.

8. The antenna module of claim 2, wherein the plurality of layers further comprise a fourth layer between the third layer and the ground layer, and
wherein the antenna module further comprises a feed line in the fourth layer that is configured to feed the transmission signal to the one or more vias.

9. The antenna module of claim 1, wherein the first stub comprises a first-first sub-stub and a first-second sub-stub having different widths, and the second stub comprises a second-first sub-stub and a second-second sub-stub having different widths.

10. The antenna module of claim 2, wherein the first stub is configured to filter an n^{th} harmonic component (n is a natural number equal to or greater than 2) of the transmission signal, and the second stub is configured to filter an (n+1)^{th} harmonic component of the transmission signal.

11. The antenna module of claim 10, wherein at least one of a width and a length of each of the first stub and the second stub is set to filter the n^{th} harmonic component and the (n+1)^{th} harmonic component.

12. The antenna module of claim 8, wherein the ground layer comprises a plurality of ports, and the feed line is connected to at least one of the plurality of ports.

13. An antenna module comprising:
a ground layer comprising a plurality of ports; and
an antenna structure on the ground layer and comprising:
a plurality of layers comprising a first layer, a second layer and a third layer, wherein the second layer and the third layer are between the ground layer and the first layer;
one or more vias extending through at least a portion of the plurality of layers;
a radiating element in the first layer;
a first stub in the second layer and extending from the one or more vias; and
a second stub in the third layer and extending from the one or more vias, wherein the one or more vias are connected to at least one of the plurality of ports.

14. The antenna module of claim 13, wherein at least one of the plurality of ports is connected to the radiating element through the one or more vias.

15. The antenna module of claim 13, further comprising a plurality of vias formed through a plurality of via holes in the ground layer, wherein the plurality of vias are configured to transmit a transmission signal to the antenna structure.

16. The antenna module of claim 15, wherein each of the first stub and the second stub is configured to filter a harmonic component of the transmission signal.

17. The antenna module of claim 15, wherein a strength of a harmonic component of the transmission signal is lower in the radiating element than in each of the first stub and the second stub.

18. A device comprising:
a radio frequency integrated circuit (RFIC) configured to process a transmission signal; and
an antenna module configured to transmit the transmission signal, the antenna module comprising:
a ground layer configured to transmit the transmission signal provided from the RFIC to the antenna module; and
an antenna structure stacked on the ground layer and comprising:
a plurality of layers comprising a first layer, a second layer and a third layer, wherein the second layer and the third layer are between the ground layer and the first layer;
one or more vias extending through at least a portion of the plurality of layers;
a radiating element in the first layer;
a first stub in the second layer and extending from the one or more vias; and
a second stub in the third layer and extending from the one or more vias.

19. The device of claim 18, wherein each of the first stub and the second stub is configured to filter a harmonic component of the transmission signal.

20. The device of claim 19, wherein each of the first stub and the second stub has a length corresponding to one-fourth (¼) of a guided wavelength of the harmonic component.
